(19) United States
(12) Patent Application Publication
(10) Pub. No.: US 2023/0384530 A1
(43) Pub. Date: Nov. 30, 2023

(54) FERRULE FOR OPTICAL CONNECTOR AND METHOD OF MANUFACTURING OPTICAL CONNECTOR

(71) Applicant: Fujikura Ltd., Tokyo (JP)

(72) Inventor: Masayuki Hirose, Sakura-shi (JP)

(73) Assignee: Fujikura Ltd., Tokyo (JP)

(21) Appl. No.: 18/250,750

(22) PCT Filed: Aug. 16, 2021
(86) PCT No.: PCT/JP2021/029892

§ 371 Date: Apr. 27, 2023

(30) Foreign Application Priority Data
Feb. 17, 2021 (JP) 2021-023527

(51) Int. Cl. G02B 6/38

(52) U.S. Cl. CPC G02B 6/3826; G02B 6/3854; G02B 6/3885; G02B 6/3882

(57) ABSTRACT

A ferrule, for an optical connector, includes: a main body part formed with a fiber hole configured to accommodate insertion of an optical fiber. The main body part is formed of a material having a coefficient of linear expansion within a range of 1.7×10⁻⁵ to 3.0×10⁻⁵. A ratio of an inner diameter dh of the fiber hole to an outer diameter df of a cladding of the optical fiber is within a range of 99.632 [%]≤dh/df≤99.880 [%].

### CROSS-REFERENCE TO RELATED APPLICATIONS

The present application is a national stage application of PCT Application No. PCT/JP2021/029892, filed on Aug. 16, 2021, which claims priority to Japanese Patent Application No. 2021-023527, filed on Feb. 17, 2021. The contents of these documents are incorporated by reference in their entirety.

### TECHNICAL FIELD

The present invention relates to a ferrule for an optical connector and a method of manufacturing an optical connector.

### BACKGROUND

Patent Document 1 discloses that an optical fiber is inserted into a fiber hole having an inner diameter substantially equal to an outer diameter of the optical fiber by heating a ferrule.

### CITATION LIST

### Patent Document

### [Patent Document 1]

Japanese Unexamined Patent Application, First Publication No. H5-88045

If an inner diameter of a fiber hole is the same as an outer diameter of an optical fiber, a gap may be generated between the fiber hole and the optical fiber by an influence of manufacturing variations.

### SUMMARY

As a result of intensive studies by the inventors of the present application, it has been found that, it is possible to more reliably suppress positional deviation of the optical fiber by making an inner diameter of a fiber hole smaller than an outer diameter of an optical fiber. However, if an inner diameter of a fiber hole is simply made smaller than an outer diameter of an optical fiber, the optical fiber cannot be inserted through the fiber hole.

One or more embodiments of the present invention provide a ferrule for an optical connector and a method of manufacturing an optical connector in which it is possible to insert an optical fiber through a fiber hole, and it is possible to more reliably suppress positional deviation of the optical fiber.

A ferrule for an optical connector according to one or more embodiments of the present invention includes a main body part in which a fiber hole into which an optical fiber is to be inserted is formed, in which the main body part is formed of a material having a coefficient of linear expansion within a range of 1.7×10⁻⁵ to 3.0×10⁻⁵, and a ratio of an inner diameter dh of the fiber hole to an outer diameter df of a cladding of the optical fiber is within a range of 99.632 [%]≤dh/df≤99.880 [%].

According to the ferrule for an optical connector of one or more embodiments, the inner diameter dh of the fiber hole is smaller than the outer diameter df of the cladding of the optical fiber. Thereby, it is possible to more reliably suppress generation of a gap between the optical fiber and the fiber hole after the optical connector is assembled. Therefore, it is possible to suppress positional deviation of the optical fiber, and it is possible to match a central axis of the fiber hole and a central axis of the optical fiber with each other with high accuracy. Also, the material of the main body part has a coefficient of linear expansion within a range of 1.7×10⁻⁵ to 3.0×10⁻⁵, and 99.632 [%]≤dh/df≤99.880 [%] is satisfied. Thereby, it is possible to make the inner diameter of the fiber hole larger than the outer diameter of the cladding by heating to a predetermined temperature (for example, 100° C. to 150° C.). That is, in the ferrule for an optical connector of one or more embodiments, it is possible to insert the optical fiber into the fiber hole by heating to a predetermined temperature.

Here, the main body part may be formed of a material having a coefficient of linear expansion within a range of 1.7×10⁻⁵ to 2.1×10⁻⁵, and a ratio of the inner diameter dh of the fiber hole to the outer diameter df of the cladding may be within a range of 99.744 [%]≤dh/df≤99.880 [%].

Also, a material of the main body part may be PEEK, and a ratio of the inner diameter dh of the fiber hole to the outer diameter df of the cladding may be within a range of 99.776 [%]≤dh/df≤99.864 [%].

Also, a method of manufacturing an optical connector according to one or more embodiments of the present invention includes a preparation step of preparing an optical fiber and a ferrule for an optical connector which includes a main body part in which a fiber hole is formed, an insertion step of inserting the optical fiber into the fiber hole with the main body part heated to 100° C. or higher, and a cooling step of fixing the optical fiber in the fiber hole by cooling the main body part, in which, before heating, a ratio of an inner diameter dh of the fiber hole to an outer diameter df of a cladding of the optical fiber is within a range of 99.632 [%]≤dh/df≤99.880 [%].

According to the manufacturing method of one or more embodiments, the inner diameter dh of the fiber hole is smaller than the outer diameter df of the cladding of the optical fiber before heating. Therefore, it is possible to more reliably suppress generation of a gap between the optical fiber and the fiber hole after the optical connector is assembled. Therefore, it is possible to suppress positional deviation of the optical fiber, and it is possible to match center axes of the fiber hole and the optical fiber with each other with high accuracy.

Also, the material of the main body part has a coefficient of linear expansion within a range of 1.7×10⁻⁵ to 3.0×10⁻⁵, 99.632 [%]≤dh/df≤99.880 [%] is satisfied, and the main body part is heated to 100° C. or higher in the insertion step.

Thereby, it is possible to make the inner diameter of the fiber hole larger than the outer diameter of the cladding. Therefore, it is possible to insert the optical fiber through the fiber hole.

Further, by performing the cooling step after the insertion step, it is possible to fix the optical fiber in the fiber hole by a force of thermal shrinkage acting on the ferrule.

According to one or more embodiments of the present invention, it is possible to provide a ferrule for an optical connector and a method of manufacturing an optical connector in which it is possible to insert an optical fiber through a fiber hole, and it is possible to more reliably suppress positional deviation of the optical fiber.

### BRIEF DESCRIPTION OF THE DRAWINGS

FIG. 1 is a perspective view of an optical connector according to one or more embodiments.

FIG. 2 is a cross-sectional view along line II-II indicated by the arrow in FIG. 1.

FIG. 3A is a view illustrating a relationship between a dimension of a fiber hole and a dimension of an optical fiber before heating.

FIG. 3B is a view illustrating a relationship between a dimension of the fiber hole and a dimension of the optical fiber after heating.

### DETAILED DESCRIPTION

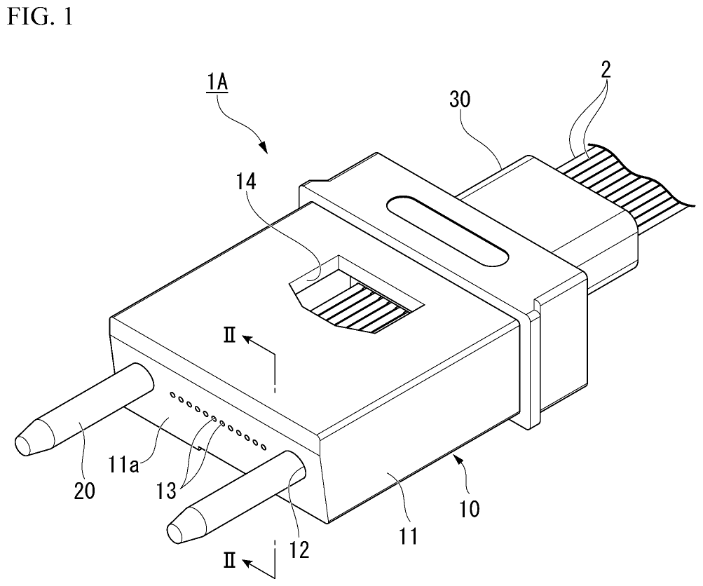

As illustrated in FIG. 1, an optical connector 1A includes a plurality of optical fibers 2, a ferrule 10 (ferrule for an optical connector), two guide pins 20, and a boot 30. The ferrule 10 includes a main body part 11 in which a plurality of fiber holes 13 through which the optical fibers 2 are inserted are formed. Two guide holes 12 are formed in the main body part 11. The main body part 11 has a connection end surface 11a at which the fiber holes 13 and the guide holes 12 open. Also, a filling hole 14 is formed at an upper surface of the main body part 11. The filling hole 14 communicates with an internal space of the main body part 11.

The guide pin 20 is inserted through each of the guide holes 12. Note that, the optical connector 1A illustrated in FIG. 1 is a male side and includes the guide pin 20, but an optical connector on a female side does not have the guide pin 20. By inserting the guide pins 20 of the optical connector 1A on the male side through the guide holes 12 of the optical connector on the female side, positions of the ferrules 10 of the two optical connectors are aligned. On the male side and the female side, shapes of the ferrules 10 may be the same.

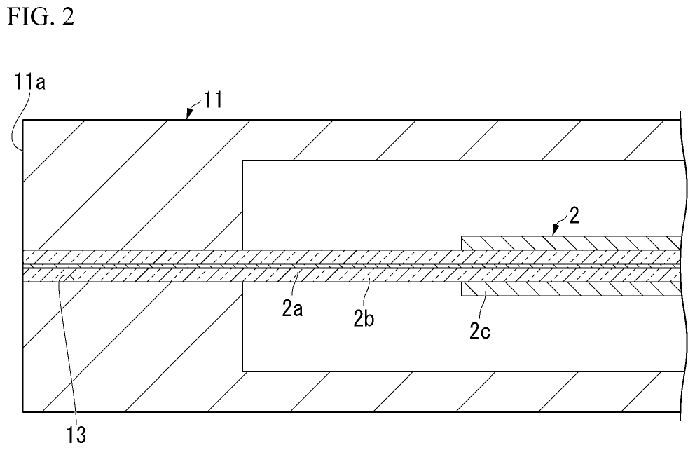

As illustrated in FIG. 2, the optical fibers 2 each have a core 2a, a cladding 2b, and a coating layer 2c. The cladding 2b covers the core 2a, and the coating layer 2c covers the cladding 2b. The core 2a and cladding 2b are formed of glass. A refractive index of the cladding 2b is lower than a refractive index of the core 2a. Therefore, it is possible to confine light within the core 2a. The coating layer 2c is formed of a resin or the like. At an end portion of the optical fiber 2, the coating layer 2c is removed to expose the cladding 2b. Of the optical fiber 2, the end portion in which the cladding 2b is exposed is inserted into the fiber hole 13.

It is possible to employ polyether ether ketone (PEEK), liquid crystal polymers (LCP), polyetherimide (PEI), polyphenylene sulfide (PPS), and the like, or a mixture thereof as a material of the main body part 11 of the ferrule 10. A filler such as glass fibers may be added to the material described above. As the material of the main body part 11, a resin other than those described above may be employed.

Next, a method of manufacturing the optical connector 1A will be described.

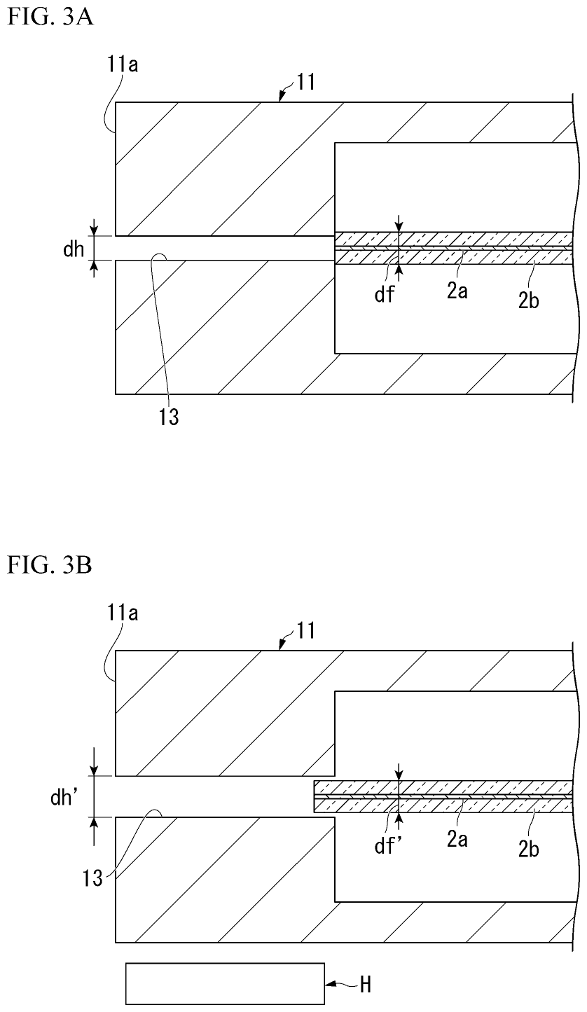

First, the optical fibers 2 and the ferrule 10 are prepared (preparation step). Here, FIG. 3A illustrates the optical fiber 2 and the fiber hole 13 at room temperature (25° C.) before the optical fiber 2 is inserted into the fiber hole 13. As illustrated in FIG. 3A, in the present specification, an inner diameter of the fiber hole 13 and an outer diameter of the cladding 2b at room temperature are expressed as dh and df, respectively. At room temperature, dh is smaller than df. That is, the inner diameter of the fiber hole 13 is smaller than the outer diameter of the cladding 2b.

Next, as illustrated in FIG. 3B, a heater H is used to heat the ferrule 10. The optical fiber 2 may be heated when the ferrule 10 is heated. Alternatively, only the ferrule 10 may be heated without heating the optical fiber 2. A temperature of the ferrule 10 during heating may be appropriately set, and is, for example, 100° C. or higher. As illustrated in FIG. 3B, in the present specification, an inner diameter of the fiber hole 13 and an outer diameter of the cladding 2b in a state in which they are heated to a predetermined temperature are expressed as dh′ and df′, respectively.

When heated to a predetermined temperature, dh′ is larger than df′. This is because a coefficient of linear expansion of the ferrule 10 is larger than a coefficient of linear expansion of glass (the core 2a and the cladding 2b). That is, due to a difference in coefficient of linear expansion between the ferrule 10 and the glass, a magnitude relation between the fiber hole 13 and the cladding 2b is reversed as they are heated. As described above, during heating, it is possible to insert the optical fiber 2 into the fiber hole 13 because the inner diameter of the fiber hole 13 is larger than the outer diameter of the cladding 2b. Then, a light emitting end (distal end) of the optical fiber 2 is inserted to a position of the connection end surface 11a (insertion step).

After the optical fiber 2 is inserted into the fiber hole 13, the ferrule 10 is cooled to room temperature (cooling step). At this time, the fiber hole 13 tries to thermally shrink to a dimension smaller than the outer diameter of the cladding 2b. It is possible to fix the cladding 2b in the fiber hole 13 due to this shrinkage force. As a result, a positional relationship between the optical fiber 2 and the main body part 11 of the ferrule 10 is configured as illustrated in FIG. 2. It is possible to fix the optical fiber 2 to the ferrule 10 as described above. Also, since the fiber hole 13 tries to thermally shrink to a dimension smaller than the outer diameter of the cladding 2b, a gap is not easily generated between the fiber hole 13 and the cladding 2b. Therefore, it is possible to perform positioning of the optical fiber 2 with higher accuracy.

Note that, after the cooling step, an adhesive or the like may be injected into the main body part 11 through the filling hole 14. In this case, it is possible to more firmly fix the optical fiber 2 to the ferrule 10. Note that, it is possible to fix the optical fiber 2 by the shrinkage force acting in the cooling step. Therefore, injection of the adhesive through the filling hole 14 is not indispensable. Also, the filling hole 14 may not be formed in the main body part 11.

If the optical fiber 2 protrudes from the connection end surface 11a of the ferrule 10, the protruding portion of the optical fiber 2 may be polished together with the connection end surface 11a. Thereby, it is possible to match a position of an end surface of the optical fiber 2 with a position of the connection end surface 11a.

Next, a relationship between the dimensions dh and df will be described.

As described above, in one or more embodiments, the difference in coefficient of linear expansion (hereinafter, simply referred to as “difference in linear expansion coefficient”) between the main body part 11 of the ferrule 10 and the glass (the core 2a and the cladding 2b) is utilized. In order to make it easier to insert the optical fiber 2 into the fiber hole 13 during heating, a value of dh′−df′ may be large. As the difference in linear expansion coefficient becomes larger, it is possible to make the value of dh′−df′ larger during heating, while maintaining dh<df at room temperature.

Hereinafter, more detailed conditions will be described using Table 1. Note that, “GF 70%” for a material A means that glass fibers are added in a weight ratio of 70%. The same applies to other materials. Also, the same also applies to Table 2.

TABLE 1

| | | Coefficient of linear | | Heating temperature | | | | |
|---|---|---|---|---|---|---|---|---|
| | | expansion [/° C.] | | 25° C. | 100° C. | 120° C. | 130° C. | 150° C. |
| Material of ferrule | | Ferrule | Glass | dh′ − df′ [μm] | | | | |
| Material A | PPS (GF 70%) | 1.7 × 10⁻⁵ | 5.2 × 10⁻⁷ | 0.00 | 0.15 | 0.20 | 0.22 | 0.26 |
| Material B | PPS (GF 60%) | 3.0 × 10⁻⁵ | 5.2 × 10⁻⁷ | 0.00 | 0.28 | 0.35 | 0.39 | 0.46 |
| Material C | PEEK (GF 60%) | 1.9 × 10⁻⁵ | 5.2 × 10⁻⁷ | 0.00 | 0.17 | 0.21 | 0.24 | 0.28 |
| Material D | LCP (GF 50%) | 2.1 × 10⁻⁵ | 5.2 × 10⁻⁷ | 0.00 | 0.19 | 0.24 | 0.27 | 0.32 |
| Material E | PEI (GF 30%) | 2.0 × 10⁻⁵ | 5.2 × 10⁻⁷ | 0.00 | 0.18 | 0.23 | 0.26 | 0.30 |

For example, in a case of the material A, PPS (coefficient of linear expansion being 1.7×10⁻⁵) to which glass fibers are added in a weight ratio of 70% is used as the material of the main body part 11 of the ferrule 10. The column of “dh′−df” represents what the value of dh′−df′ will be when heated to each heating temperature in a case in which dimensions at room temperature are dh=df=125 μm. For example, in the column of “100° C.” of the material A, dh′−df′=0.15 μm. This means that, when the inner diameter of the fiber hole 13 and the outer diameter of the cladding 2b are equal at room temperature, if they are heated to 100° C., the inner diameter of the fiber hole 13 becomes larger than the outer diameter of the cladding 2b by 0.15 μm. Conversely, in a case of the material A, even if dh at room temperature is smaller than df by 0.15 μm, if the ferrule 10 is heated to 100° C. or higher in the insertion step, it is possible to insert the optical fiber 2 into the fiber hole 13. It is possible to calculate the numerical value of “dh′−df” rom the difference in linear expansion coefficient and the dimensions of dh and df at room temperature.

A material B has a coefficient of linear expansion larger than that of the material A. Therefore, the inner diameter of the fiber hole 13 becomes larger as it is heated. Therefore, the value of “dh′−df” of the material B is larger than that of the material A when they are compared. Similarly, in other materials, the larger the coefficient of linear expansion is, the larger the value of “dh′−df′” is.

TABLE 2

| | | Heating temperature | | | | |
|---|---|---|---|---|---|---|
| | | 25° C. | 100° C. | 120° C. | 130° C. | 150° C. |
| Material of ferrule | | dh/df′ [%] | | | | |
| Material A | PPS (GF 70%) | 100 | 99.880% | 99.840% | 99.824% | 99.792% |
| Material B | PPS (GF 60%) | 100 | 99.776% | 99.720% | 99.688% | 99.632% |
| Material C | PEEK (GF 60%) | 100 | 99.864% | 99.832% | 99.808% | 99.776% |
| Material D | LCP (GF 50%) | 100 | 99.848% | 99.808% | 99.784% | 99.744% |
| Material E | PEI (GF 30%) | 100 | 99.856% | 99.816% | 99.792% | 99.760% |

Table 2 shows a lower limit value of a ratio of dh/df of each material at room temperature calculated on the basis of Table 1 so that it is possible to insert the optical fiber 2 into the fiber hole 13 during heating. For example, when the heating temperature is 100° C. in the material A, as shown in Table 1, even if the inner diameter of the fiber hole 13 at room temperature is smaller than the outer diameter of the cladding 2b by 0.15 μm, it is possible to insert the optical fiber 2 into the fiber hole 13 by heating. In other words, if the inner diameter of the fiber hole 13 at room temperature is 124.85 μm or more, it is possible to insert the optical fiber 2 with the outer diameter of 125 μm into the fiber hole 13 by heating. For generalization, if the lower limit value (124.85 μm) of the inner diameter of the fiber hole 13 at room temperature is divided by the outer diameter (125 μm) of the cladding 2b, it becomes 124.85/125×100=99.880%. Therefore, it is described as 99.880% in Table 2 when the heating temperature of the material A is 100° C. It is also possible to similarly calculate for other materials on the basis of Table 1.

As illustrated in Table 1, when the heating temperature is 100° C., the dh/df value of each material is 99.880% or less. That is, if any of the materials A to E is used and the heating temperature is set to 100° C. or higher, when the inner diameter dh of the fiber hole 13 at room temperature is set to 99.88% or higher of the outer diameter df of the cladding 2b, it is possible to insert the optical fiber 2 into the fiber hole 13 during heating. Also, coefficients of linear expansion of the materials shown in the materials A to E are within a range of 1.7×10⁻⁵ to 3.0×10⁻⁵.

As shown in Table 1, if the heating temperature of the material B is 150° C., a lower limit value of dh/df is 99.632%. That is, if the material of the ferrule 10 is PPS (GF 60%), the inner diameter dh of the fiber hole 13 at room temperature is set to 99.632% or more of the outer diameter df of the cladding 2b, and the heating temperature is set to 150° C. or higher. Thereby, it is possible to insert the optical fiber 2 into the fiber hole 13.

Summarizing the above, in the present specification, it is proposed that the main body part 11 of the ferrule 10 is formed of a material having a coefficient of linear expansion within a range of 1.7×10⁻⁵ to 3.0×10⁻⁵, and a ratio of the inner diameter dh of the fiber hole 13 to the outer diameter df of the cladding 2b of the optical fiber 2 at room temperature is set within a range of 99.632 [%]≤dh/df≤99.880 [%]. According to such a configuration, the inner diameter dh of the fiber hole 13 at room temperature is smaller than the outer diameter df of the cladding 2b. Thereby, it is possible to suppress generation of a gap between the fiber hole 13 and the cladding 2b after the optical connector 1A is assembled. Therefore, it is possible to suppress positional deviation of the optical fiber 2, and it is possible to match a central axis of the fiber hole 13 and a central axis of the optical fiber 2 (core 2a) with each other with high accuracy. On the other hand, when the ferrule 10 is heated to a predetermined temperature (for example, 100 to 150° C.) or higher, the inner diameter dh′ of the fiber hole 13 becomes larger than the outer diameter df′ of the cladding 2b. Therefore, it is possible to insert the optical fiber 2 through the fiber hole 13.

Moreover, in the present specification, the following is proposed as a manufacturing method for the optical connector 1A. That is, the manufacturing method includes a preparation step of preparing the optical fiber 2 and the ferrule 10 which has the main body part 11 in which the fiber hole 13 is formed, an insertion step of inserting the optical fiber 2 into the fiber hole 13 while the main body part 11 is heated to 100° C. or higher, and a cooling step of fixing the optical fiber 2 in the fiber hole 13 by cooling the main body part 11, and in which a ratio of the inner diameter dh of the fiber hole 13 to the outer diameter df of the cladding 2b of the optical fiber 2 before heating is set within a range of 99.632 [%]≤dh/df≤99.880 [%]. According to such a manufacturing method, it is possible to provide the optical connector 1A in which positional deviation of the optical fiber 2 with respect to the fiber hole 13 is suppressed.

Here, the materials A, C, D, and E have coefficients of linear expansion within a range of 1.7×10⁻⁵ to 2.1×10⁻⁵. As described above, when a material having a relatively small coefficient of linear expansion is used, there is an advantage in that the ferrule 10 easily returns to its original shape when it is cooled after being heated. For example, if the heating temperature of the material D is 150° C., a lower limit value of dh/df is 99.744%. That is, if the material of the ferrule 10 is LCP (GF 50%), when the inner diameter dh of the fiber hole 13 at room temperature is set to 99.744% or more of the outer diameter df of the cladding 2b and the heating temperature is set to 150° C. or higher, it is possible to insert the optical fiber 2 into the fiber hole 13.

Therefore, in the present specification, it is proposed that the main body part 11 of the ferrule 10 is formed of a material having a coefficient of linear expansion within a range of 1.7×10⁻⁵ to 2.1×10⁻⁵, and a ratio of the inner diameter dh of the fiber hole 13 to the outer diameter df of the cladding 2b of the optical fiber 2 at room temperature is set within a range of 99.744 [%]≤dh/df≤99.880 [%]. According to such a configuration, it is possible to make a shape of the ferrule 10 after heating and cooling more stable, and it is possible to position the optical fiber 2 with higher accuracy.

Also, PEEK also has an advantage that it is excellent in heat resistance. For example, if the heating temperature of the material C is 150° C., a lower limit value of dh/df is 99.776%. That is, if the material of the ferrule 10 is PEEK (GF 60%), when the inner diameter dh of the fiber hole 13 at room temperature is set to 99.776% or more of the outer diameter df of the cladding 2b and the heating temperature is set to 150° C. or higher, it is possible to insert the optical fiber 2 into the fiber hole 13. If the dh/df value at room temperature is 99.848%, the heating temperature may be set to 100° C. or higher.

Therefore, in the present specification, it is proposed that PEEK is used as the material of the main body part 11, and a ratio of the inner diameter dh of the fiber hole 13 to the outer diameter df of the cladding 2b of the optical fiber 2 at room temperature is set within a range of 99.776 [%]≤dh/df≤99.8848 [%]. According to such a configuration, it is possible to provide the ferrule 10 in which it is possible to position the optical fiber 2 with high accuracy and which has heat resistance.

Note that, the technical scope of the present invention is not limited to the above-described embodiments, and various modifications may be made without departing from the gist of the present invention.

For example, in the above-described embodiments, the ferrule 10 having the plurality of fiber holes 13 has been described. However, the number of the fiber holes 13 of the ferrule 10 may be one.

Also, a shape of the ferrule 10 may be changed as appropriate and may have, for example, a columnar shape.

In addition, the components in the above-described embodiments may be appropriately replaced with well-known components within a range not departing from the gist of the present invention, and the embodiments and modified examples described above may be appropriately combined.

### REFERENCE SIGNS LIST

1A Optical connector
2 Optical fiber
2b Cladding
10 Ferrule
11 Main body part
13 Fiber hole
df Outer diameter of cladding
dh Inner diameter of fiber hole

1. A ferrule for an optical connector, the ferrule comprising:
a main body part formed with a fiber hole configured to accommodate insertion of an optical fiber, wherein
the main body part is formed of a material having a coefficient of linear expansion within a range of 1.7×10⁻⁵ to 3.0×10⁻⁵, and
a ratio of an inner diameter dh of the fiber hole to an outer diameter df of a cladding of the optical fiber is within a range of 99.632 [%]≤dh/df≤99.880 [%].

2. The ferrule according to claim 1, wherein
the coefficient of linear expansion of the material of the main body part is within a range of 1.7×10⁻⁵ to 2.1×10⁻⁵, and
the ratio of the inner diameter dh of the fiber hole to the outer diameter df of the cladding is within a range of 99.744 [%]≤dh/df≤99.880 [%].

3. The ferrule according to claim 1, wherein
the material of the main body part is polyether ether ketone (PEEK), and
the ratio of the inner diameter dh of the fiber hole to the outer diameter df of the cladding is within a range of 99.776 [%]≤dh/df≤99.864 [%].

4. A method of manufacturing an optical connector comprising:
preparing an optical fiber and a ferrule that includes a main body part formed with a fiber hole;
inserting the optical fiber into the fiber hole with the main body part heated to 100° C. or higher; and
fixing the optical fiber in the fiber hole by cooling the main body part, wherein
before heating, a ratio of an inner diameter dh of the fiber hole to an outer diameter df of a cladding of the optical fiber is within a range of 99.632 [%]≤dh/df≤99.880 [%].

5. The ferrule according to claim 2, wherein
the material of the main body part is polyether ether ketone (PEEK), and
the ratio of the inner diameter dh of the fiber hole to the outer diameter df of the cladding is within a range of 99.776 [%]≤dh/df≤99.864 [%].
